(19) United States
(12) Patent Application Publication
(10) Pub. No.: US 2015/0033144 A1
(43) Pub. Date: Jan. 29, 2015

(54) METHOD AND APPARATUS FOR REGISTERING SCHEDULE IN PORTABLE TERMINAL

(71) Applicant: Samsung Electronics Co., Ltd., Suwon-si (KR)

(72) Inventor: Kyungtae KIM, Hwaseong-si (KR)

(21) Appl. No.: 14/338,856

(22) Filed: Jul. 23, 2014

(30) Foreign Application Priority Data
Jul. 23, 2013 (KR) 10-2013-0086792

(51) Int. Cl. G06F 3/0484; H04L 29/08

(52) U.S. Cl. CPC G06F 3/04842; H04L 67/02
USPC 715/752

(57) ABSTRACT

A method and an apparatus for displaying a user interface of schedule registration in an electronic device are provided. The method includes receiving a user conversation including schedule related contents in one of a voice and text form, displaying a schedule message generated based on the user conversation on a screen of the electronic device, and displaying a selectable reserved schedule other than the displayed schedule message if a user's modification request is received for the schedule message. According to the present disclosure, a user convenience is improved and the user may intuitively identify a schedule registration method because a schedule may be registered without a direct input of the user by analyzing a natural language of user conversation in a character or voice form.

### CROSS REFERENCE TO RELATED APPLICATION(S)

This application claims the benefit under 35 U.S.C. §119(a) of a Korean patent application filed on Jul. 23, 2013 in the Korean Intellectual Property Office and assigned Serial number 10-2013-0086792, the entire disclosure of which is hereby incorporated by reference.

### TECHNICAL FIELD

The present disclosure relates to a method and an apparatus for registering a schedule in a portable terminal. More particularly, the present disclosure relates to a method and an apparatus for registering a schedule in which reserved schedules are extracted by analyzing a user conversation and a schedule is registered according to a user's selection.

### BACKGROUND

According to developments in electronic devices and software, portable terminals became to be combined with various functions and the portability of electronic devices is improving. According to addition of various functions into a mobile communication terminal, character information, image information, MP3, games, and the like are provided for a user.

In particular, a schedule function is one of basic functions provided to manage a schedule in the mobile communication terminal and the user may for example, set, modify, and confirm the schedule by using the schedule function.

However, the conventional schedule function has a disadvantage because a user must input schedule contents and time information through an input unit for the registration of schedule.

For example, when making an appointment in a specific day through a telephone conversation, the user may have to separately make a memo and input a schedule in the portable terminal after finishing the conversation. Even though some portable terminals support a multi-tasking function, the procedure of inputting for the schedule registration cannot be avoided.

Therefore, a method and an apparatus for effectively registering a schedule for a voice communication, video communication, chatting application, and the like of the portable terminal are needed.

There are difficulties in extracting correct schedule information due to limits of conventional voice recognition and conversation analysis. An error in extracting information causes user's inconvenience of re-inputting required information. The present disclosure is to solve the above problems and difficulties.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above mentioned problems and/or disadvantages and to provide at least the advantages described below. Accordingly, an aspect of the present disclosure is to provide an apparatus and method for registering a schedule in a portable terminal

In accordance with an aspect of the present disclosure, a method for displaying a user interface of schedule registration in an electronic device is provided. The method includes receiving a user conversation including schedule related contents in one of a voice and text form, displaying a schedule message generated based on the user conversation on the screen of the electronic device, and displaying a selectable reserved schedule other than the displayed schedule message on the screen of the electronic device if a user's modification request is received for the schedule message.

Further, the displaying of the schedule message may include extracting schedule related contents respectively for date, time, location, subject, and member by analyzing the user conversation, deciding priorities of reserved schedules having a high coincidence possibility from the extracted schedule related contents, and generating a first schedule message from a reserved schedule having a highest possibility.

In accordance with another aspect of the present disclosure, an apparatus for displaying a user interface of schedule registration in an electronic device is provided. The apparatus includes a screen configured to display a schedule message, and a control unit configured to receive a user conversation including schedule related contents in one of a voice and text form, to display a schedule message generated based on the user conversation on a screen of the electronic device, and to display a selectable reserved schedule other than the displayed schedule message on the screen of the electronic device if a user's modification request is received for the schedule message.

The control unit is further configured to extract schedule related contents respectively for date, time, location, subject, and member by analyzing the user conversation, to decide priorities of reserved schedules having a high coincidence possibility from the extracted schedule related content, and to generate a first schedule message from a reserved schedule having the highest possibility.

In accordance with another aspect of the present disclosure, a method for generating a scheduling event in an electronic device is provided. The method includes receiving data at the electronic device including schedule related contents in one of a voice and text form, extracting the schedule related contents from the received data, displaying on a screen of the electronic device a first scheduling event message generated based on the extracted schedule related contents, selecting the first scheduling event message, and storing the selected first scheduling message.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an internal structure of an electronic device according to an embodiment of the present disclosure;

FIG. 2 is a flow chart illustrating a procedure of extracting schedule contents by analyzing a user conversation and displaying a reserved schedule according to an embodiment of the present disclosure;

FIG. 3 is a flow chart illustrating a procedure of updating schedule contents according to an embodiment of the present disclosure;

FIG. 4 is a drawing illustrating an example of displaying a schedule message while using a chatting application according to an embodiment of the present disclosure;

FIGS. 5A and 5B are drawings illustrating examples of displaying a selectable reserved schedule besides the firstly displayed schedule according to an embodiment of the present disclosure; and

FIG. 6 is a drawing illustrating an example of displaying a schedule message in a voice communication according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some components in the accompanying drawings are emphasized, omitted, or schematically illustrated, and the size of each component does not fully reflect the actual size. Therefore, the present disclosure is not limited to the relative sizes and distances illustrated in the accompanying drawings.

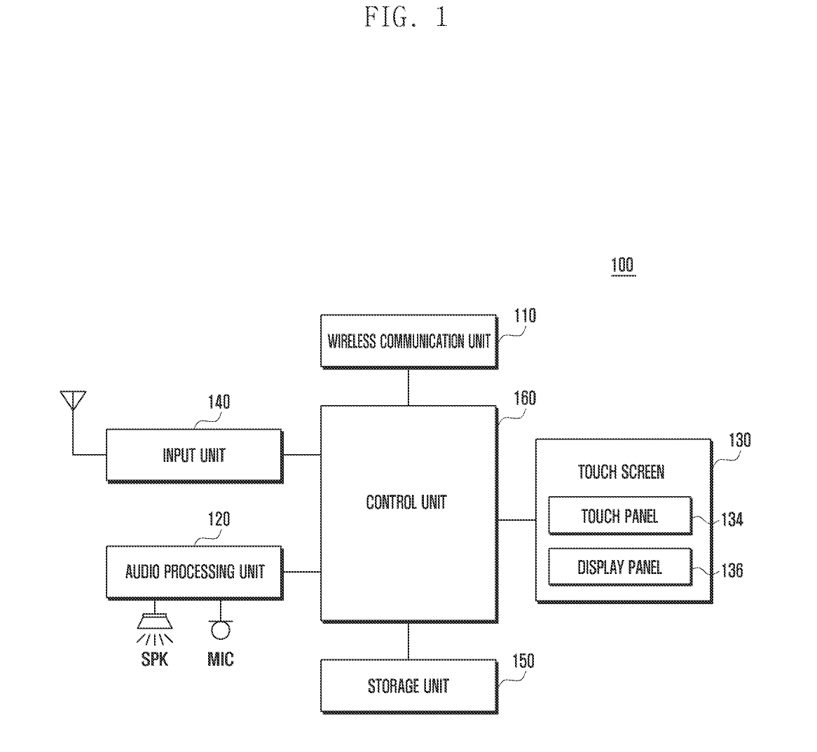

FIG. 1 is a block diagram illustrating an internal structure of an electronic device according to an embodiment of the present disclosure.

As shown in FIG. 1, the electronic device 100 according to an embodiment of the present disclosure may include a wireless communication unit 110, audio processing unit 120, touch screen 130, input unit 140, storage unit 150, and control unit 160.

The wireless communication unit 110 performs a data communication function for a wireless communication. The wireless communication unit 110 may be configured with an RF transmitter for amplifying and up-converting the frequency of a signal to be transmitted, and an RF receiver for low noise amplifying and down-converting the frequency of received signal. Further, the wireless communication unit 110 receives data through a wireless channel in order to transmit the data to the control unit 160, and transmits the data received from the control unit 160 through the wireless channel.

The audio processing unit 120 may be configured with a codec, and the codec may include a data codec for processing packet data and an audio codec for processing an audio signal. The audio processing unit 120 converts a digital audio signal to an analog audio signal through the audio codec and plays an audio through a speaker SPK, and converts an analog audio signal received from a microphone MIC to a digital audio signal through the audio codec.

The touch screen 130 may include a touch panel 134 and a display panel 136. The touch panel 134 may detect a user's touch input. The touch panel 134 may be configured with a touch detection sensor such as a capacitive overlay, resistive overlay, infrared beam, and pressure sensor, but is not limited thereto. That is, the touch panel 134 according to the present disclosure may be configured with any other sensor which may detect a contact with an object or a pressure.

The touch panel 134 detects a user's touch input, and generates a detection signal to transmit to the control unit 160. The detection signal includes coordinates data of a user's touch. If the user moves a touch location, the touch panel 134 generates coordinates data including a touch movement path in order to transmit to the control unit 160.

In particular, the touch panel 134 may receive a user's modification request for a schedule message according to an embodiment of the present disclosure. For example, the user's modification request may be a touch input maintained for a time which is related to detailed contents such as a displayed time, location, and attendance included in the schedule message.

The display panel 136 may be configured with a Liquid Crystal Display (LCD), Organic Light Emitting Diodes (OLED), or Active Matrix Organic Light Emitting Diodes (AMOLED), and visually provides a menu of the electronic device 100, input data, function setting information, or various information for a user. Further, the display panel 136 may display various information of notifying operation states of the electronic device 100 for the user.

Particularly in the various embodiments of the present disclosure, the display panel 136 performs a function of displaying a schedule message. The schedule message may include contents related to a date, time, location, subject, or member, but is not limited thereto.

Although the electronic device 100 according to the present disclosure may be configured by including a touch screen as described above, it is to be understood that the various embodiments of the present disclosure described hereafter are not limited to the electronic device 100 having a touch screen. When an electronic device not having a touch screen is applied to the present disclosure, the touch screen 130 shown in FIG. 1 may be modified to perform only the function of the display panel 136, and the function of the touch panel 134 may be replaced by that of the input unit 140.

The input unit 140 receives a user input for controlling the electronic device 100 and transmits an input signal to the control unit 160. The input unit 140 may be configured with a keypad having numeral keys and direction keys, and specific function keys may be further formed at a side of the electronic device 100. In another embodiment of the present disclosure, the electronic device 100 may operate only with the touch screen 130. In this case, the touch panel 134 performs the function of the input unit 140.

Particularly in the various embodiments of the present disclosure, the input unit 140 may receive user inputs for registering a schedule message and selecting a reserved schedule.

The storage unit 150 may perform a role of storing programs and data required for the operation of the electronic device 100, and may include a program area and a data area, but is not limited thereto.

The program area may store default programs such as an Operating System (OS) and programs for controlling general operations of the electronic device 100. Further, the program area of the storage unit 150 may store applications installed by a user such as a game application and a social network service application.

The data area is an area for storing data generated according to the use of the electronic device 100, and may store an image, video, phonebook, and audio data, but is not limited thereto. Particularly in the various embodiments of the present disclosure, the data area may store schedule information.

The control unit 160 controls general operation of the electronic device. Particularly in the electronic device 100 according to the various embodiments of the present disclosure, the control unit 160 controls to receive a user conversation including schedule related contents in one of a voice and text form from the wireless communication unit 110 and to display a schedule message generated based on the user conversation, and controls a series of operations for displaying a selectable reserved schedule together with the displayed schedule if a user's modification request for the schedule message is received.

Further, the control unit 160 extracts schedule related contents respectively for a date, time, location, subject, and member by analyzing the user conversation received by the wireless communication unit 110, decides the priorities of reserved schedules having a high possibility in matching with an actual schedule from the extracted schedule related contents, and generates a schedule message from a reserved schedule having the highest possibility.

Detailed examples of graphic interface for displaying the schedule message by continuously extracting the schedule contents will be described later referring to the accompanying drawings.

In the meantime, the control unit 160 analyzes the received user conversation after generating the schedule message, updates the schedule related contents, re-decides the priorities of reserved schedules by including the updated schedule related contents, and generates a second schedule message from a reserved schedule having the highest possibility.

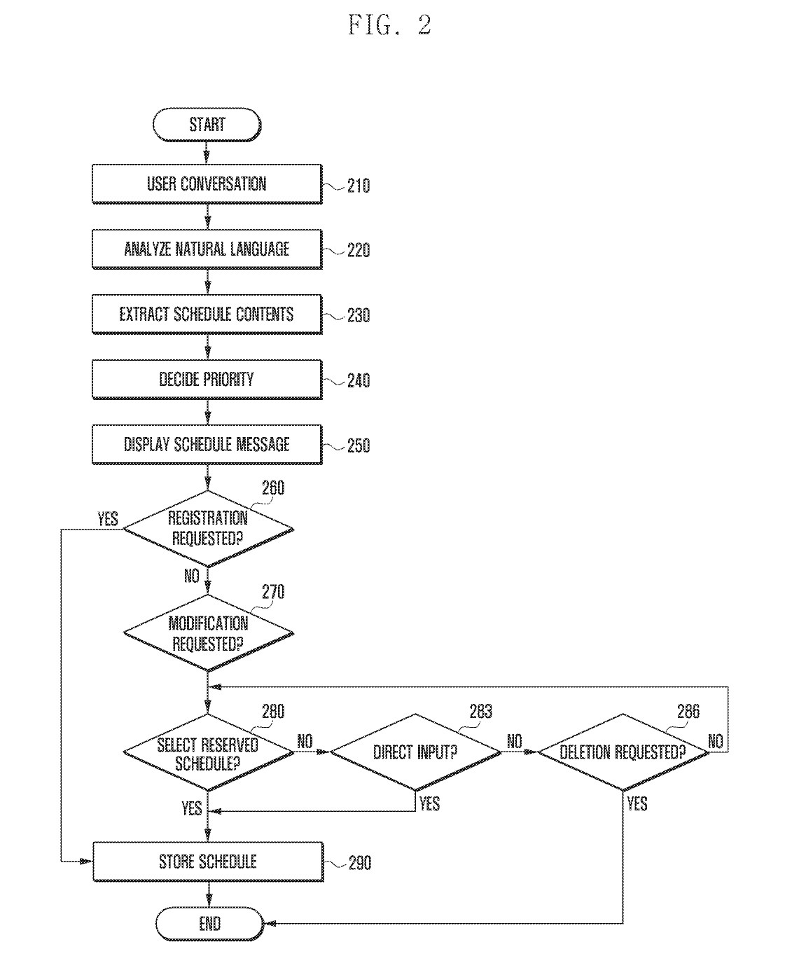

FIG. 2 is a flow chart illustrating a procedure of extracting schedule contents by analyzing a user conversation and displaying a reserved schedule according to an embodiment of the present disclosure.

The control unit 160 receives a user conversation from the wireless communication unit 110 at operation 210. The user conversation may be a voice communication, video communication, character message, multimedia message, or chatting message, but is not limited thereto. The user conversation received from the wireless communication unit 110 may be recorded in the storage unit 150 by using an Automatic Send/Receive Set (ARS).

The control unit 160 performs a natural language analysis of the user conversation at operation 220 and extracts schedule contents at operation 230. For example, if the user conversation is “Shall we meet at 6 o'clock today evening in Yangjae? Lets' see at 8 o'clock because 6 o'clock is not free for me”, the control unit 160 may extract “6 o'clock today evening”, “8 o'clock today evening”, “Yangjae” as keywords and delete “6 o'clock today evening” by reflecting the result of natural language analysis. The control unit 160 may extract “8 o'clock today evening” as schedule contents.

The control unit 160 decides the priority of the extracted schedule contents at operation 240. Here, the natural language analysis may be applied also. In the above example, the control unit 160 may decide the priority in the order of “6 o'clock today evening, Yangjae” and “8 o'clock today evening, Yangjae” by reflecting the analysis result of natural language after extracting “6 o'clock today evening,” “8 o'clock today evening”, “Yangjae”. Besides the natural language analysis, a high priority may be set to a schedule extracted from the contents of the most recently spoken language as another method for deciding the priority.

The control unit 160 controls the display panel 136 to display a schedule message at operation 250. The schedule message may be a message asking whether to register a reserved schedule having the highest possibility identified at operation 240.

Detailed examples of graphic interface for displaying a schedule message by extracting schedule contents from a user conversation will be described later referring to the accompanying drawings.

Subsequently, the control unit 160 receives a user's registration request from the input unit 140 at operation 260. If the user requests for registration, the corresponding schedule is registered at operation 290.

If the user doesn't request for registration, the control unit 160 receives a user's registration request from the input unit 140 at operation 270. The control unit 160, which received the user's registration request, controls the display panel 136 to display selectable reserved schedules besides the displayed schedule. This is to enable a more flexible schedule registration by letting the user select a reserved schedule.

If one of the displayed reserved schedules is selected by a user at operation 280, the control unit 160 registers the corresponding schedule at operation 290. However, if the user selects a direct input at operation 283, the control unit 160 receives a user's input from the input unit 140 and registers the corresponding schedule at operation 290.

If the user decides to delete a reserved schedule at operation 286, the control unit 160 doesn't store the corresponding schedule and terminates the process.

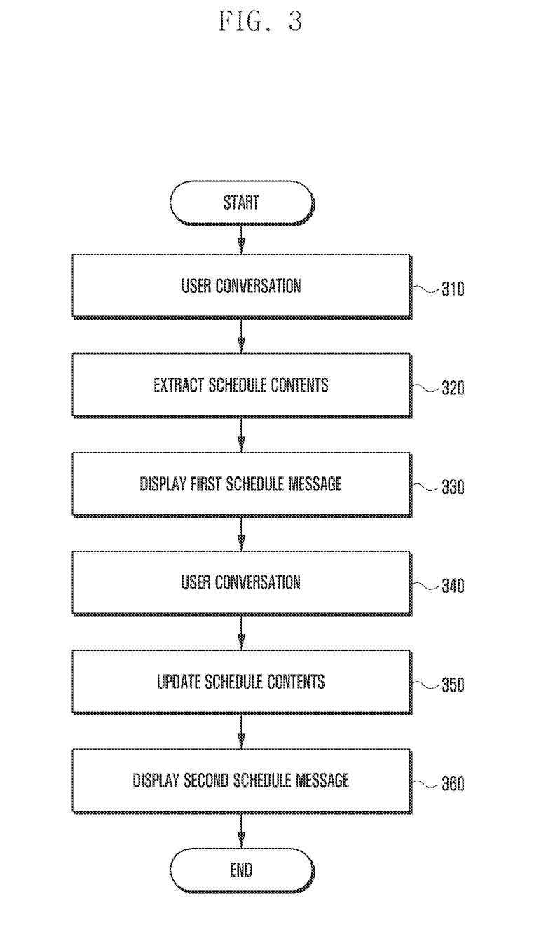

FIG. 3 is a flow chart illustrating a procedure of updating schedule contents according to an embodiment of the present disclosure.

According to the embodiment of the present disclosure, after displaying a message (first schedule message) asking whether to register a schedule having a high priority, a second schedule message may be displayed if an update of schedule is required due to continued user conversation. FIG. 3 illustrates a flow chart for an update procedure of the schedule contents.

The control unit 160 receives a user conversation from the wireless communication unit 110 at operation 310. The user conversation may be a voice communication, video communication, character message, multimedia message, or chatting message, but is not limited thereto.

The control unit 160 performs a natural language analysis for the user conversation and extracts schedule contents at operation 320. Here, the control unit 160 may decide a reserved schedule most suitable for an actual situation by identifying the priority of the extracted schedule contents.

Subsequently, the control unit 160 displays a first schedule message asking whether to register a schedule having the highest priority at operation 330. After displaying the first schedule message, an update of the schedule may be required if the user conversation is continued at operation 340.

This may be applied in the same way if the user has already registered the schedule contents. For example, the user conversation may be continued for the next day's schedule after registering the schedule by selecting the first schedule message “Register the schedule of 8 o'clock today evening in Yangjae?”.

Accordingly, the control unit 160 may update the schedule contents at operation 350. For example, the control unit 160 may update the schedule contents and re-decide the priority by adding a newly reserved schedule to the extracted schedule at operation 320.

In this case, the natural language analysis may be applied and a high priority is set to a schedule extracted from the most recently spoken contents.

The control unit 160 displays a second schedule message asking whether to register a reserved schedule having the highest possibility by including the updated schedule contents at operation 360.

The first and second schedule messages may be displayed in a text chatting window. For example, the control unit 160 may display the first schedule message at the bottom of the terminal screen and replace it with the second schedule message at the same location. Alternatively, the control unit 160 may display in the order of the first schedule message, a text chatting generated after displaying the first schedule message, and the second schedule message.

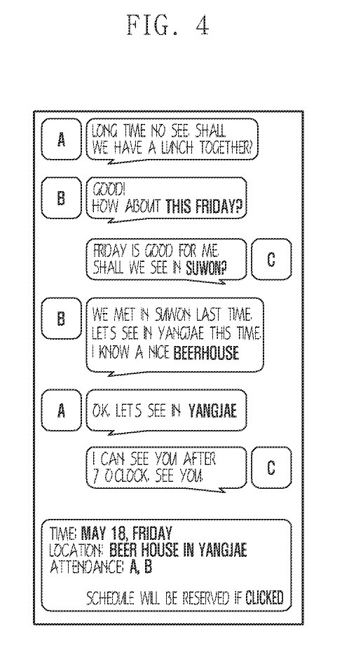

FIG. 4 is a drawing illustrating an example of displaying a schedule message while using a chatting application according to an embodiment of the present disclosure.

FIG. 4 illustrates an example of a chatting window using an application for a portable terminal, and conversation participants including their portable terminal, such as, portable terminal user C, A, and B.

From the user conversation in a text chatting form shown in FIG. 4, the control unit 160 may extract i) Time: Friday this week, ii) Location: Suwon, Yangjae, beerhouse, iii) Attendance or Participants: A, B, and C, as a reserved schedule.

Further, from the reserved schedules, the control unit 160 may extract i) Time: Friday this week, ii) Location: beerhouse in Yangjae, iii) Attendance: A, B, and C by selecting a reserved schedule most suitable for an actual situation through the natural language analysis.

As shown in FIG. 4, the message asking for a schedule may be displayed by fixing at the bottom area of the screen displaying a chatting window, but is not limited thereto. For example, according to the embodiment of the present disclosure, the message may be displayed not only in the bottom area of the screen but also in the bottom area of the chatting contents for the extracted schedule. In this case, the message may be moved to the top area of the chatting window according to the display state of the chatting contents.

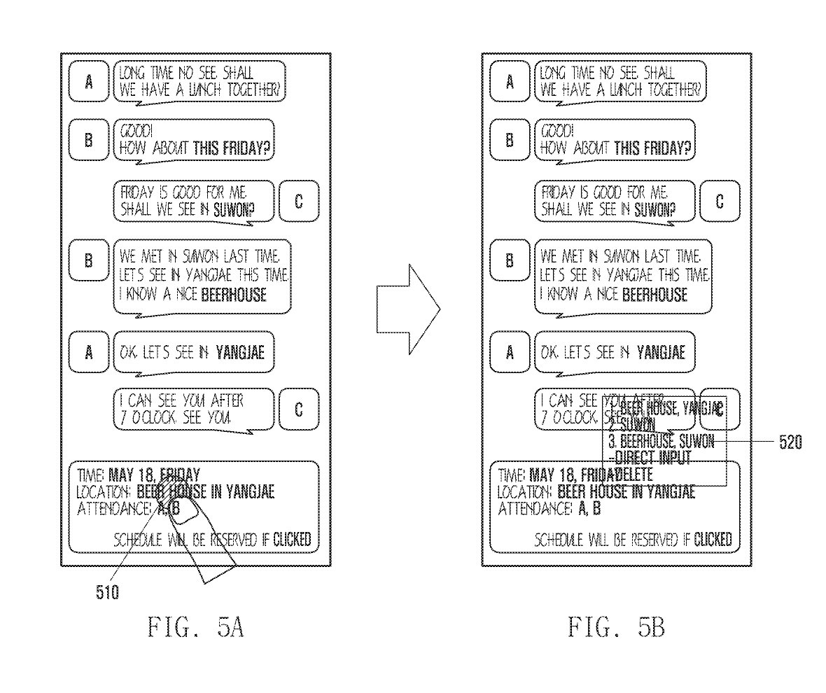

FIGS. 5A and 5B are drawings illustrating examples of displaying a selectable reserved schedule besides the firstly displayed schedule according to an embodiment of the present disclosure.

Referring to FIGS. 5A and 5B, a user may not want to select a schedule message provided by the control unit 160. Here, if other reserved schedules are provided for the user, the registration of schedules may be made more flexibly and affirmatively.

If the user wants to register a schedule other than the displayed schedule, a schedule message displayed according to a modification request may be selected by using a touch input as shown in FIG. 5A.

For example, the user may touch time information to modify the time, location information to modify the location, and attendance information to modify the attendees. FIGS. 5A and 5B illustrate an example of inputting a touch in order to modify the location.

A selectable reserved schedule may be displayed as shown in FIG. 5B, if a modification request is received from the user.

If the modification request is received from the user, other schedules having a different location extracted from the chatting message are displayed in the order of priorities, a direct input is asked to the user, and a selectable reserved schedule to be deleted may be displayed as shown in FIG. 5B. The selectable reserved schedule may be displayed in a pop-up window as shown in FIG. 5B.

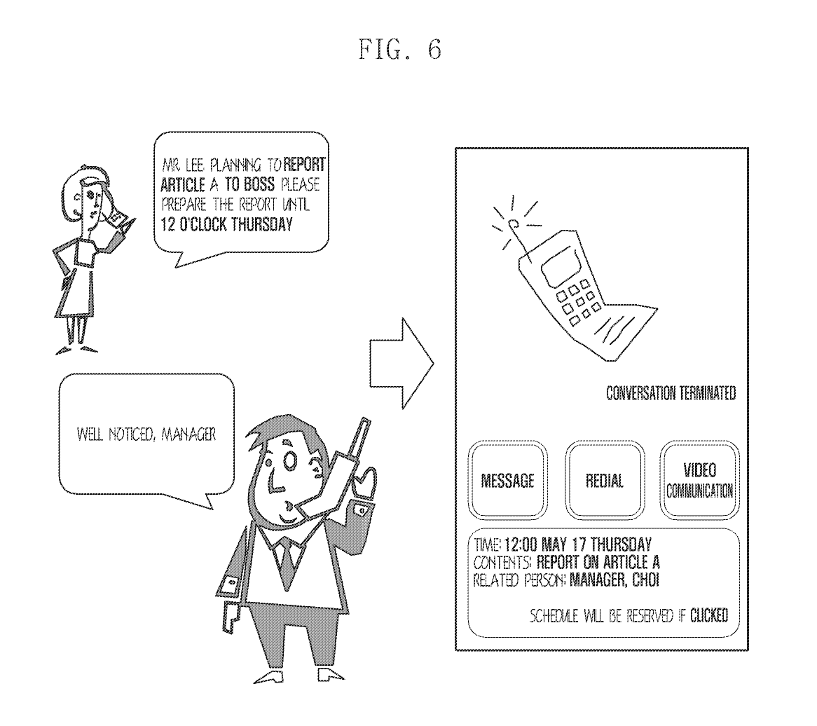

FIG. 6 is a drawing illustrating an example of displaying a schedule message in a voice communication according to an embodiment of the present disclosure.

The control unit 160 may extract i) Time: 12 o'clock Thursday, ii) Contents: Report on article A, iii) Related person: counterpart of communication as a reserved schedule, from the voice communication contents shown in FIG. 6.

In this case, the control unit 160 may decide the priorities of reserved schedules through the natural language analysis, and display a message asking whether to register the schedule including i) Time: 12 o'clock Thursday (May 17), ii) Contents: Report on article A, iii) Related person : Manager Choi (counterpart of communication) as shown in FIG. 6.

The schedule message may be displayed at the bottom of the screen 130 if the communication is finished as shown in FIG. 6. Further, the schedule message may be displayed on the screen 130 even when the communication is continued. This is because the user may want to directly register a schedule during the communication.

According to the present disclosure, a user convenience is improved and the user may intuitively identify a schedule registration method because a schedule may be registered without a direct input by analyzing a natural language of user conversation in a character or voice form.

Further, according to the present disclosure, a schedule function of a portable terminal may be used more flexibly registered because the user may select a reserved schedule.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for displaying a user interface of schedule registration in an electronic device, the method comprising:
receiving a user conversation including schedule related contents in one of a voice and text form;
displaying a schedule message generated based on the user conversation on a screen of the electronic device; and
displaying a selectable reserved schedule other than the displayed schedule message on the screen of the electronic device if a user's modification request is received for the schedule message.

2. The method of claim 1, wherein the displaying of the schedule message comprises:
extracting schedule related contents respectively for date, time, location, subject, and member by analyzing the user conversation;
deciding priorities of reserved schedules having a high coincidence possibility from the extracted schedule related contents; and
generating a first schedule message from a reserved schedule having a highest possibility.

3. The method of claim 2, further comprising:
updating the schedule related contents by analyzing the user conversation received after generating the first schedule message;
re-deciding the priorities of the reserved schedules by including the updated schedule related contents and generating a second schedule message from the reserved schedule having the highest possibility; and
displaying the second schedule message on the screen of the electronic device.

4. The method of claim 3, wherein the displaying of the selectable reserved schedule comprises displaying at least one selectable reserved schedule in order of high priorities if the user's modification request is received.

5. The method of claim 4, wherein the displaying of the selectable reserved schedule comprises displaying a message requesting a user's direct one of an input and deletion together with the selectable reserved schedule.

6. The method of claim 5, wherein the displaying of the schedule message comprises displaying a message requesting a user's schedule registration for the reserved schedule having the highest possibility.

7. The method of claim 6, wherein the displaying of the schedule message comprises displaying a schedule message at a bottom of the screen of the electronic device displaying the last text chatting if the schedule related contents are extracted when the user conversation is text chatting through an application.

8. The method of claim 6, wherein the displaying of the schedule message comprises displaying the schedule message on the screen of the electronic device displaying the end of one of a communication and execution of communication if the schedule related contents are extracted when the user conversation is a voice communication.

9. An apparatus for displaying a user interface of schedule registration in an electronic device, the apparatus comprising:
a screen configured to display a schedule message; and
a control unit configured to receive a user conversation including schedule related contents in one of a voice and text form, to display a schedule message generated based on the user conversation in a screen of the electronic device, and to display a selectable reserved schedule other than the displayed schedule message on the screen of the electronic device if a user's modification request is received for the schedule message.

10. The apparatus of claim 9, wherein the control unit is further configured to extract schedule related contents respectively for date, time, location, subject, and member by analyzing the user conversation, to decide priorities of reserved schedules having a high coincidence possibility from the extracted schedule related contents, and to generate a first schedule message from a reserved schedule having a highest possibility.

11. The apparatus of claim 10, wherein the control unit is further configured to update the schedule related contents by analyzing the user conversation received after generating the schedule message, to re-decide the priorities of the reserved schedules by including the updated schedule related contents and to generate a second schedule message from a reserved schedule having the highest possibility, and to display the second schedule message on the screen of the electronic device.

12. The apparatus of claim 11, wherein the control unit is further configured to display at least one selectable reserved schedule in order of high priorities if the user's modification request is received.

13. The apparatus of claim 12, wherein the control unit is further configured to display a message requesting one of a user's direct input and deletion together with the selectable reserved schedule.

14. The apparatus of claim 13, wherein the control unit is further configured to display a message requesting a user's schedule registration for the reserved schedule having the highest possibility.

15. The apparatus of claim 14, wherein the control unit is further configured to display a schedule message at the bottom of the screen of the electronic device displaying the last text chatting if the schedule related contents is extracted when the user conversation is text chatting through an application.

16. The apparatus of claim 14, wherein the control unit is further configured to display the schedule message on the screen of the electronic device displaying one of an end of communication and execution of communication if the schedule related contents is extracted when the user conversation is a voice communication.

17. A method for generating a scheduling event in an electronic device, the method comprising:
receiving data at the electronic device including schedule related contents in one of a voice and text form;
extracting the schedule related contents from the received data;
displaying on a screen of the electronic device a first scheduling event message generated based on the extracted schedule related contents;
selecting the first scheduling event message; and
storing the selected first scheduling message.

18. The method of claim 17, further comprising displaying on the screen of the electronic device a second scheduling event message if a modification of the first scheduling event message is requested.

19. The method of claim 17, further comprising, after extracting the schedule related contents from the received data, analyzing the extracted schedule related contents and assigning a higher priority to the extracted schedule related contents based on most recently received data at the electronic device.
